(19) United States
(12) Patent Application Publication
(10) Pub. No.: US 2014/0350755 A1
(43) Pub. Date: Nov. 27, 2014

(54) METHOD AND SYSTEM FOR AIDING PILOTING WHEN SELECTING A TRAJECTORY OF APPROACH

(71) Applicant: THALES, NEUILLY SUR SEINE (FR)

(72) Inventors: Christophe CAILLAUD, BLAGNAC (FR); Jerome SACLE, TOURNEFEUILLE (FR)

(21) Appl. No.: 14/285,246

(22) Filed: May 22, 2014

(30) Foreign Application Priority Data
May 24, 2013 (FR) 1301187

(51) Int. Cl. G08G 5/02

(52) U.S. Cl. CPC G08G 5/02
USPC 701/18

(57) ABSTRACT

A method and system for aiding piloting when selecting a trajectory of approach of an airport or airfield, implemented on at least one processor, includes a first step of selecting a landing airport or airfield, and a second step of determining, for said landing airport or airfield, all or part of the possible trajectories of approach associated with a landing runway, on the basis of a database of the airports or airfields. A third step determines, for at least one of the possible approaches, whether or not said approach is compatible with an angular guidance mode, by geometrical analysis of the approach; and a fourth step displays all of said possible approaches, for said landing airport or airfield, and of displaying the compatibility with said angular guidance mode for the approaches analyzed.

### CROSS-REFERENCE TO RELATED APPLICATION

This application claims priority to foreign French patent application No. FR 1301187, filed on May 24, 2013, the disclosure of which is incorporated by reference in its entirety.

### FIELD OF THE INVENTION

The invention lies in the field of flight management systems (also known by the acronym “FMS”).

### BACKGROUND

For reasons of homogeneity and also to facilitate the formation of crews, certain aircraft have an angular guidance function (also known by the acronym “FLS” for “FMS Landing System”) which can also be used during the flight following a so-called non-precision approach (also known by the acronym “NPA”). FLS guidance is based only on devices that are on board the aircraft whereas other angular approaches (ILS, MLS) require a beacon on the ground to guide the aircraft. This angular guidance function cannot, however, be used for all approaches, particularly if the final convergence of the approach does not observe certain criteria presented in the document. Moreover, the angular guidance function does not meet the necessary criteria for flying so-called Required Navigation Performance approaches, also known by the acronym “RNP AR”.

The Honeywell patent U.S. Pat. No. 8,121,747 is known in the prior art and presents a method in which the flight management system proposes by default the use of angular guidance to perform all the approaches. This type of guidance can be changed by the pilot in order to use another type of guidance, for example vertical guidance, also known by the expression “FINAL descent mode”. When the pilot selects an approach and wishes to perform it using angular guidance the flight management system then determines whether or not angular guidance can be used for this approach. This decision is taken by considering the level of performance necessary to perform this approach (this level is defined during the design of the procedure in the airspace in question), as well as the final convergence of the approach. The method described in this document then informs the pilot of any possible incompatibility of the selected approach with angular guidance. However this incompatibility is only indicated following the selection of the approach by the pilot. Thus, this system has the drawback of requiring the pilot to make another choice of approach if the first choice of approach does not allow the use of angular guidance.

### SUMMARY OF THE INVENTION

The subject of the present invention is therefore a flight management method that makes it possible to facilitate the choice of an approach by the pilot. According to an aspect of the invention, a method for aiding piloting when selecting a trajectory of approach of an airport or airfield is proposed, implemented on a flight management system deployed on board an aircraft, said method including the following steps:
a first step of selecting a landing airport or airfield by a pilot,
a second step of determining, for said selected landing airport or airfield, all or part of the possible trajectories of approach associated with a landing runway of the selected airport, on the basis of a database of the airports or airfields comprising the description of all the possible approaches for the various airfields or airports,
a third step of determining, for at least one of the possible approaches, whether or not said approach is compatible with an angular guidance mode, by geometrical analysis of the approach,
said third step (103) being adapted to verify one of the following conditions:
   a final segment of the flight plan of said approach, described using the A424 standard, is of RF type,
   an angle between an axis of the runway associated with the approach and said final segment is above a given angle,
   said approach requires a navigation performance below a given threshold,
   a magnetic declination, at the level of said runway associated with the approach, is not known,
   the pilot indicates that the angular approach mode must not be used,
   the inclination of descent, used by the angular guidance mode, does not lie within the interval of inclinations compatible with a descent profile associated with the approach;
said third step (103) being adapted to indicate that the approach is incompatible with an angular guidance mode if one of these conditions is verified.
a fourth step of displaying all of said possible approaches, for said landing airport or airfield, and of displaying the compatibility with said angular guidance mode for the approaches analyzed.

The given angle lies between 45° and 55° with 50° as preferred value. The threshold lies between 0.1 and 0.25.

In one embodiment, the selection method furthermore includes:
a fifth step of selecting one of the displayed approaches,
a sixth step of parameterizing the flight management system in order to use the selected approach.

If the magnetic declination is not known then it is not possible to compute a magnetic orientation on the basis of the geographic orientation. Therefore, a lateral angular guidance beam cannot be constructed on the basis of a point of origin in proximity to the runway.

The magnetic declination is, at a given point on the surface of the Earth, the angle formed between the direction of the geographic North pole and the magnetic North.

In one embodiment, the sixth, parameterizing step is furthermore adapted to deselect the angular guidance mode, if the aircraft leaves a flight plan compatible with an angular guidance mode, and to indicate to the pilot that the new flight plan is incompatible with an angular guidance mode.

This technical feature makes it possible, when the flight management system detects that the angular guidance mode is no longer compatible with the contents of the flight plan, following a modification by the crew for example, to automatically deselect the angular guidance mode and to warn the crew of this loss of capability via the display of a message.

In one embodiment, the method is implemented on at least one processor incorporated into a flight management system deployed on board an aircraft.

In one embodiment, the method is implemented on:
at least one processor incorporated into a flight management system deployed on board an aircraft, and
at least one processor incorporated into a ground system and adapted to implement the third step.

A system is also proposed for aiding piloting when selecting a trajectory of approach of an airport or airfield including:
a flight management system deployed on board an aircraft,
a navigation database comprising the description of all the possible approaches for the various airfields or airports that the aircraft can use,
a formatting tool comprising at least one processor adapted to determine, for said landing airport or airfield, all or part of the possible approach trajectories associated with a landing runway on the basis of said database of the airports or airfields, said processor including an area for storing the computational data,
a visual user interface exchanging information with the processor and allowing:
   the selection of an airport or airfield by the pilot,
   the display of the possible approaches for the selected airfield or airport with for each approach an indication of the compatibility with an angular guidance mode,
   the selection of one of the approaches by the pilot;
the flight management system being able to be configured by the processor as a function of the selected approach.

The system is moreover adapted to implement the steps of the method described previously.

According to a technical feature, the system furthermore comprises: p1 a formatting tool, implemented outside the flight management system and adapted to determine, for part of the possible approaches for part of the airports or airfields that the aircraft can use, whether or not said approaches are compatible with an angular guidance mode;
downloading means enabling the downloading of data representing the compatibility of the approaches with the angular guidance mode, between the formatting tool and the navigation database.

### BRIEF DESCRIPTION OF THE DRAWINGS

The invention will be better understood and other advantages will become apparent upon reading the detailed description, given by way of non-limiting example. This detailed description is made using the following figures:

FIG. 1 shows a first embodiment of the method of the invention,

FIG. 2 shows a second embodiment of the method of the invention,

FIG. 3 shows a system implementing the method.

### DETAILED DESCRIPTION

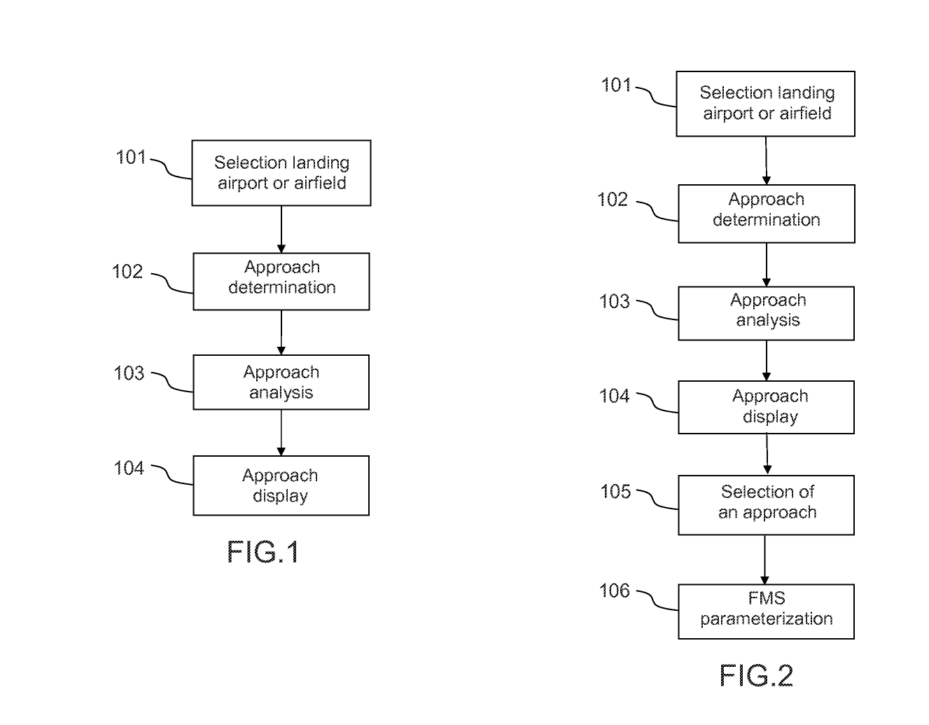

FIG. 1 shows the method of the invention. This method includes the following steps: a first step of selection 101 of a landing airport or airfield by a pilot. This item of information is transmitted to the flight management system. Next, a step 102 of determining all or part of the trajectories of approach that can be performed for this selected airport or airfield. This step is performed by the flight management system. A step of analysis 103, for at least one of the approaches, making it possible to determine whether or not the approach is compatible with an angular guidance mode. This step is performed by the flight management system which performs a geometrical analysis of the approach.

The third step 103 verifies one of the following conditions:

a final segment of the flight plan of the approach, described using the A424 standard, is of RF type,

an angle between an axis of the runway associated with the approach and the final segment is above a given angle,

the approach requires a navigation performance below a given threshold,

a magnetic declination, at the level of said runway associated with the approach, is not known,

the pilot indicates that the angular mode of approach must not be used,

the inclination of descent, used by the angular guidance mode, does not lie within the interval of inclinations compatible with a descent profile associated with the approach.

The third step 103 indicates that the approach is incompatible with an angular guidance mode if one of these conditions is verified.

The method then includes a step 104 of displaying to the pilot all the approaches associated with the airport or airfield and, for the analyzed approaches, the compatibility with the angular guidance mode.

In another embodiment, shown in FIG. 2, the method furthermore comprises a fifth step 105 of the pilot selecting a displayed approach, this item of information being transmitted to the flight management system, and a sixth step 106 of parameterizing the flight management system depending on the approach that has been selected by the pilot. The method according to this embodiment is then a method of selecting a trajectory of approach.

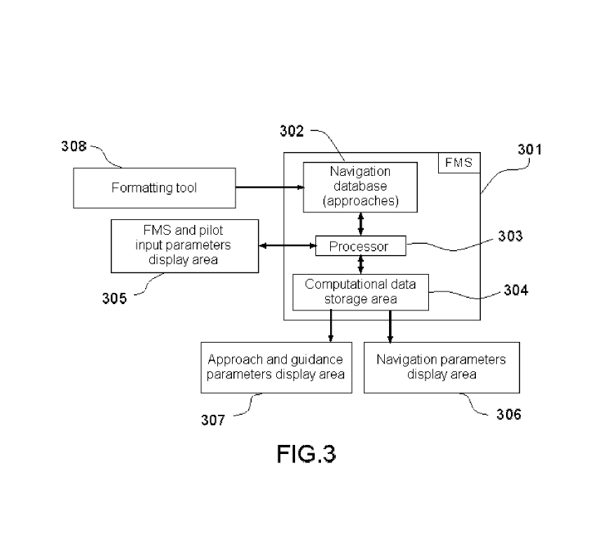

FIG. 3 shows a mode of implementation of the method of the invention. This method is implemented in one or more flight management systems 301 which include a navigation database 302. This database comprises the description of all the possible approaches for the various airports or airfields that the aircraft can use. In a navigation database, associated with an airport, the possible approaches are referenced. For example, a given airport has a runway that can be used in both directions and moreover each runway receives a code allowing it to be identified, for example RW10 or RW28. Moreover, for each runway the possible approach methods are indicated (ILS, VOR (for “VHF Omnidirectional Range” which is a radio positioning system) and RNAV/GNSS (non-precision approach procedure with instruments based on the global satellite navigation system)); the database then contains a code making it possible to identify the approach used by a runway and composed of the concatenation of the approach code and the runway code, for example ILS RW10, ILS RW28, VOR RW10, VOR RW28, RNAV RW10 or RNAV RW28. The flight management system or flight management systems also comprise a processor 303 in charge of various computations and areas 304 for storing or saving computational data. The system also comprises a visual user interface 305. This user interface allows:
the selection of an airport or airfield by the pilot;
the display of the possible approaches for the selected airfield or airport with for each approach an indication of the compatibility with an angular guidance mode;
the selection of one of the approaches by the pilot.

This interface can therefore be composed of a display area showing the data received from the flight management system(s) and allowing the inputting by the pilot of parameters intended for the flight management system(s). Moreover, the visual interface includes an area 306 for displaying data relating to the navigation, an area 307 for displaying data relating to the approach and to guidance, and an area for displaying data relating to the main piloting parameters.

In the first mode of implementation, the pilot indicates the destination airfield or airport in the flight plan to the flight management system, via the user interface. Next, the step of determining all or part of the trajectories of approach for the airport is performed by the processor 303 of the flight management system.

Next, a step of analysis of all or part of the approaches makes it possible to access and determine the set of manoeuvres that the aircraft must perform to carry out the approach and to verify the compatibility of the approach with the angular guidance mode.

The flight management system chooses which approaches to analyze by removing the precision approaches, which have their own angular guidance means. The precision approaches have a label indicating ILS, IGS, GLS and MLS. ILS signifies “Instrument Landing System”. The ILS is the most precise radio navigation means used for landing. IGS is a landing system with instruments. GLS signifies “GPS Landing System”. MLS signifies “Microwave Landing System”. This other approach technology uses a beacon emitting on another frequency range to that used by a system of ILS type.

The flight management system also removes the non-precision approaches marked LOC, BC and LDA which can be categorized as precision approaches. This step is performed by the processor 303 and the results are stored in the area 205 for storing computational data.

The processor then seeks to find out whether the approach procedure under analysis comprises one of the following criteria:

the final flight segment following the A424 standard is of RF (radius to fix) type,

the angle between the runway axis and the flight segment is above a value lying in an interval from 45° to 55° with 50° as preferred value.

the approach procedure requires a navigation performance below a value lying in the interval from 0.25 to 0.1,

the magnetic declination is not known. This is because if the magnetic declination is not known then it is not possible to compute a magnetic orientation on the basis of the geographic orientation. Therefore, a lateral angular guidance beam cannot be constructed on the basis of a point of origin in proximity to the runway.

the landing runway is not known or defined in the database of the airports or airfields inserted into the flight management system

the ILS frequency is manually adjusted in alternative mode (NAV) based on systems for adjusting radio navigation frequencies. This indicates that the pilot wishes to perform a precision approach manually without taking account of the database of approaches.

there is an incompatibility between the computed angular guidance slope and the profile of descent of the approach inserted or loaded into the flight plan of the flight management system. This happens when, along a distance D, taken from the point of origin of the angular guidance beam, the vertical profile of the angular guidance is situated below the profile of approach of the procedure. By way of example, it is considered that D has a value of 20 Nm or that this distance is determined on the basis of the position of the IAF point (initial approach point of the procedure).

If the approach procedure does not include any of these features, the processor associates with the procedure an identifier indicating that angular guidance is possible. If the procedure includes at least one of the features, the processor associates with the procedure an identifier indicating that the approach is of LNAV/VNAV type (these terms are known in the prior art and signify Lateral Navigation and Vertical Navigation respectively).

The processor repeats the step of verifying the compatibility over all the non-precision approach procedures associated with the airport or airfield, and stores the determined identifiers in the memory. However, in order not to pointlessly overload the memory associated with the controller, the storing in the memory of the information representing the compatibility with an angular guidance mode is erased when the airfield or airport initially considered is no longer used either in the active flight plan, or in the secondary flight plan.

When the pilot selects the display of the various approaches associated with the airport or airfield on the active flight plan or on the secondary flight plan, the processor displays for each tagged non-precision approach the associated identifier stored in the memory. This identifier is displayed on the graphic interface 305 or 307 viewed by the pilot.

Moreover, when the pilot selects a non-precision approach from the list, if the approach has an identifier indicating that angular guidance is possible, a possibility of deactivation of the angular guidance mode is displayed to the pilot. If the identifier indicates that the approach is of LNAV/VNAV type, no other indication is displayed to the pilot.

When the pilot selects a non-precision approach from the list:
if the approach has an identifier indicating that angular guidance is possible, the processor selects the angular guidance mode to perform this approach.
if the approach has an identifier indicating that angular guidance is possible, but the pilot deactivates the angular guidance mode, the processor selects the LNAV/VNAV guidance mode to perform this approach.
if the approach has an identifier indicating that the approach is of LNAV/VNAV type, the processor selects the LNAV/VNAV guidance mode to perform this approach.

The solution therefore makes it possible for each approach to display to the pilot whether or not this approach is compatible with the angular criteria. This compatibility analysis is performed without waiting for the selection of the approach by the pilot. This in particular makes it possible to avoid contradicting the initial choice of the mode of approach associated with an approach.

Once the approach has been selected, the waypoints and manoeuvres making it possible to join them are stored in the flight plan of the flight management system. Moreover, the system computes the parameters necessary for the angular guidance with an automatic pilot when the crew engages the approach guidance mode.

In a second embodiment, the implementation of a part of the method is remote from the flight management system towards a formatting tool 308 of the navigation database. This formatting tool is for example a database server making it possible to generate a navigation database based on the ARINC 424 format.

Thus, the second step of determination is no longer implemented on the flight management system but is implemented on a computer on the ground. It is therefore the ground computer that determines, according to the criteria disclosed below (including the geometrical criterion), whether or not an approach is compatible with an angular guidance mode. The ground computer performs, for each of the airfields/airports of the database, the verification of the compatibility of the runways of this airport or airfield, then updates the initial navigation database with this additional item of information indicating which guidance mode can be used for the approach. This new navigation database is loaded into the flight management system following the usual database loading methods, using downloading means. When the pilot selects the page of the approaches for a given airport, the flight management system has the role of presenting the information of the database, transcribing that such and such an approach is performable using an angular guidance type procedure. The flight management system also has the role of applying the choice of the mode of approach that the pilot selects.

Thus, in this second mode of implementation of the method, following the initial step of selection by a pilot of the landing airport or airfield comprising the transmission of the information relating to the selected landing airport or airfield, the processor extracts from the navigation database, for each airfield or airport, the non-precision approaches that are associated with it.

This database has been previously filled by the formatting tool. The latter has performed a step of analysis that makes it possible to determine, for each approach of the airports or airfields that the aircraft can use, whether or not this approach is compatible with an angular guidance mode, by geometrical analysis of the approach. In particular, the formatting tool seeks to find out whether or not the procedure comprises one of the following criteria:

the final flight segment following the A424 standard is of RF (radius to fix) type,

the angle between the runway axis and the approach axis is above a value lying within the interval from 45° to 55° with 50° as preferred value.

the approach procedure requires a navigation performance below a value lying within the interval from 0.25 to 0.1,

the magnetic declination is not known. Specifically, if the magnetic declination is not known then it is not possible to compute a magnetic orientation on the basis of the geographic orientation. Therefore, a lateral angular guidance beam cannot be constructed on the basis of a point of origin in proximity to the runway.

there is an incompatibility between the computed angular guidance slope and the profile of descent of the approach inserted or loaded into the flight plan of the flight management system. This happens when, along a distance D, taken from the point of origin of the angular guidance beam, the vertical profile of the angular guidance is situated below the approach profile of the procedure. By way of example, it is considered that D has a value of 20 Nm or that this distance is determined on the basis of the position of the point IAF (initial approach point of the procedure).

If the procedure does not include any of these features, the tool associates with the procedure an identifier indicating that it is possible to use angular guidance. If the procedure includes at least one of the features, the tool associates with the procedure an identifier indicating that it is possible to use a LNAV/VNAV approach.

The tool repeats the compatibility verification step for all of the approach procedures associated with an airport or airfield and indicates for each approach whether or not it is possible to use an angular guidance type approach or a LNAV/VNAV approach. Next, the database, including all this information, is loaded into the flight management system or into another item of equipment, for example an item of equipment known by the acronym EFB for “Electronic Flight Bag”.

Based on the insertion of the destination airport or airfield into the active flight plan or into a secondary flight plan, the pilot selects the arrival page to visualize the various approaches of the airport or airfield, the processor displays for each non-precision approach previously tagged FLS/FAPP the corresponding identifier on the interface seen by the pilot.

Following the step of displaying to the pilots all the approaches associated with the airport and, for the analyzed approaches, the compatibility with the angular guidance mode, and when the pilot selects a non-precision approach from the list, if the approach allows the use of an approach of angular guidance type, an option to deactivate the angular guidance is displayed to the pilot. If the approach is of LNAV/VNAV type, no other display is shown on the interface screen of the pilot.

When the pilot selects a non-precision approach from the list:
if the approach has an identifier indicating that angular guidance is possible, the processor selects the angular guidance mode to perform this approach.
if the approach has an identifier indicating that angular guidance is possible, but the pilot deactivates the angular guidance mode, the processor selects the LNAV/VNAV guidance mode to perform this approach.
if the approach has an identifier indicating that the approach is of LNAV/VNAV type, the processor selects the LNAV/VNAV guidance mode to perform this approach.

The solution still proposes an achievable mode for a non-precision approach before its insertion into the flight plan, without waiting for the selection by the approach to analyse and potentially contradict the initial choice of the mode of approach referring to it.

Moreover, in one embodiment, the sixth, parameterization step is furthermore adapted to deselect the angular guidance mode, if the aircraft leaves a flight plan compatible with an angular guidance mode, and to indicate to the pilot that the new flight plan is incompatible with an angular guidance mode.

Once the approach is selected, the waypoints and the manoeuvres allowing them to be joined together are stored in the flight plan of the flight management system.

1. A method for aiding piloting when selecting a trajectory of approach of an airport or airfield, implemented on at least one processor, said method comprising the following steps:
a first step of selecting a landing airport or airfield by a pilot,
a second step of determining, for said selected landing airport or airfield, all or part of the possible trajectories of approach associated with a landing runway of the selected airport, on the basis of a database of the airports or airfields comprising the description of all the possible approaches for the various airfields or airports,
a third step of determining, for at least one of the possible approaches, whether or not said approach is compatible with an angular guidance mode, by geometrical analysis of the approach,
said third step being adapted to verify one of the following conditions:
a final segment of the flight plan of said approach, described using the A424 standard, is of RF type,
an angle between an axis of the runway associated with the approach and said final segment is above a given angle,
said approach requires a navigation performance below a given threshold,
a magnetic declination, at the level of said runway associated with the approach, is not known,
the pilot indicates that the angular approach mode must not be used,
the inclination of descent, used by the angular guidance mode, does not lie within the interval of inclinations compatible with a descent profile associated with the approach;
said third step being adapted to indicate that the approach is incompatible with an angular guidance mode if one of these conditions is verified;
and further comprising a fourth step of displaying all of said possible approaches, for said landing airport or airfield, and of displaying the compatibility with said angular guidance mode for the approaches analyzed.

2. The method according to claim 1, further comprising:
a fifth step of selecting one of the displayed approaches,
a sixth step of parameterizing said flight management system in order to use the selected approach.

3. The method according to claim 1, wherein said sixth, parameterizing step is furthermore adapted to deselect the angular guidance mode, if the aircraft leaves a flight plan compatible with an angular guidance mode, and to indicate to the pilot that the new flight plan is incompatible with an angular guidance mode.

4. The method according to claim 1, implemented on at least one processor incorporated into a flight management system deployed on board an aircraft.

5. The method according to claim 1, implemented on:
at least one processor incorporated into a flight management system deployed on board an aircraft, and
at least one processor incorporated into a ground system and adapted to implement said third step.

6. A system for aiding piloting when selecting a trajectory of approach of an airport or airfield including:
a flight management system deployed on board an aircraft,
a navigation database comprising the description of all the possible approaches for the various airfields or airports that the aircraft can use,
a formatting tool comprising at least one processor adapted to determine, for said landing airport or airfield, all or part of the possible approach trajectories associated with a landing runway on the basis of said database of the airports or airfields, said processor including an area for storing the computational data,
a visual user interface exchanging information with the processor and allowing:
the selection of an airport or airfield by the pilot,
the display of the possible approaches for the selected airfield or airport with for each approach an indication of the compatibility with an angular guidance mode,
the selection of one of the approaches by the pilot;
the flight management system being able to be configured by said processor as a function of said selected approach,
the system being moreover adapted to implement the steps of the method according to claim 1.

7. The system according to claim 6, further comprising:
a formatting tool, implemented outside the flight management system and adapted to determine, for part of the possible approaches for part of the airports or airfields that the aircraft can use, whether or not said approaches are compatible with an angular guidance mode;
downloading means enabling the downloading of data representing the compatibility of the approaches with the angular guidance mode, between the formatting tool and the navigation database.
